(19) United States
(12) Patent Application Publication
(10) Pub. No.: US 2026/0367471 A1
(43) Pub. Date: Nov. 19, 2026

(54) CASCADED OPTICAL STRUCTURES WITH SHARED PHASE SHIFTER

(71) Applicant: HUAWEI TECHNOLOGIES CO., LTD., Shenzhen (CN)

(72) Inventors: Youfang Hu, Gent (BE); Martijn TASSAERT, Gent (BE)

(21) Appl. No.: 19/730,059

(22) Filed: Jul. 2, 2026

Related U.S. Application Data
(63) Continuation of application No. PCT/EP2024/050224, filed on Jan. 5, 2024.

(51) Int. Cl. G02F 1/225; G02F 1/21

(52) U.S. Cl. CPC G02F 1/225; G02F 1/212

(57) ABSTRACT

The disclosure proposes an optical structure, comprising: a first and a second optical interferometer structures, and a first phase shifter. The first and the second optical interferometer structures are optically connected, and each comprises a first folded arm and a second folded arm. The first folded arms of the two optical interferometer structures are located on a first side of the optical structure and share the first phase shifter. The second folded arms of the two optical interferometer structures are located on a second side of the optical structure, wherein the second side is opposite to the first side. The first phase shifter is configured to perform phase shifting on an optical signal propagating in the first folded arm of the first optical interferometer structure and on an optical signal propagating in the first folded arm of the second optical interferometer structure.

### CROSS-REFERENCE TO RELATED APPLICATIONS

This application is a continuation of International Application No. PCT/EP2024/050224, filed on Jan. 5, 2024, the disclosure of which is hereby incorporated by reference in its entirety.

### TECHNICAL FIELD

The present disclosure relates to communication networks, particularly optical communication networks. The disclosure proposes an optical structure and an optical structure system to be used for optical components in optical communication systems.

### BACKGROUND

Modern optical communication systems require components like a Variable Optical Attenuator (VOA), an Optical Switch, and a Tunable Optical Filter (TOF), e.g., with high performance, low power consumption, and high tolerance to process variations.

However, it is challenging to achieve all the desired functionalities at the same time. The desired functionalities include wavelength independence across a broad bandwidth, arbitrary initial VOA attenuation level or switch state, low power consumption, small footprint for large-scale integration, and robustness to fabrication errors.

### SUMMARY

In view of the above-discussed challenges, this disclosure aims to propose a design for an optical structure and an optical structure system, which satisfy all the above-mentioned challenging points. One objective is to provide an optical structure that can be employed for a wide range of functionalities. Another objective is to provide the optical structure with a high tolerance to process-related waveguide dimensional variations. Another objective is to achieve a small footprint of the optical structure.

These and other objectives are achieved by the solution of the present disclosure as provided in the enclosed independent claims. Advantageous implementations are further defined in the dependent claims.

A first aspect of the disclosure provides an optical structure, comprising: a first optical interferometer structure, a second optical interferometer structure, and a first phase shifter. The first optical interferometer structure and the second optical interferometer structure are optically connected, and each of the first optical interferometer structure and the second optical interferometer structure comprises a first folded arm and a second folded arm. The first folded arm of the first optical interferometer structure and the first folded arm of the second optical interferometer structure are located on a first side of the optical structure and share the first phase shifter, and the second folded arm of the first optical interferometer structure and the second folded arm of the second optical interferometer structure are located on a second side of the optical structure, wherein the second side is opposite to the first side. The first phase shifter is configured to perform phase shifting on an optical signal propagating in the first folded arm of the first optical interferometer structure and on an optical signal propagating in the first folded arm of the second optical interferometer structure.

This disclosure proposes an optical structure with two folded optical interferometer arms on two sides of the optical structure, such as the top and bottom sides. Arms on the same side share the same phase shifter. It may be worth mentioning that the two arms on the same side are folded in a way to achieve balanced/symmetric phase-shifting on the two arms sharing the same phase-shifter. For instance, the folded arms may have enough waveguide-to-waveguide spacing to avoid optical waveguide mode cross-coupling.

This type of optical structure allows low wavelength-dependent loss (WDL) over a broad bandwidth. Due to the incorporation of a shared phase shifter, a uniform phase shift is consistently applied to both folded arms of each distinct branch, ensuring synchronous phase modulation across the system. Hence, the first optical interferometer structure's WDL is almost compensated by the second optical interferometer structure's reverse WDL in the transmission spectrum. Consequently, the WDL of the entire structure is effectively maintained at a minimal level, ensuring optimal performance across an extensive optical bandwidth range.

In an implementation form of the first aspect, the optical structure further comprises a second phase shifter, wherein the second folded arm of the first optical interferometer structure and the second folded arm of the second optical interferometer structure share the second phase shifter.

In order to make the top and bottom sides of the optical structure structurally symmetric, a second phase shifter may be introduced. It is possible that the first phase shifter is an operational phase shifter, and the second phase shifter is a non-operational (dummy) phase shifter.

In an implementation form of the first aspect, the optical structure further comprises an optical connection structure, configured to optically connect the first optical interferometer structure and the second optical interferometer structure, wherein the optical connection structure is a connection waveguide, or a common coupler configured to receive optical signals from the first folded arm and the second folded arm of the first optical interferometer structure, and output optical signals to the first folded arm and the second folded arm of the second optical interferometer structure.

In an implementation form of the first aspect, the first folded arm and the second folded arm of the first optical interferometer structure have a first length difference, and/or the second folded arm and the first folded arm of the second optical interferometer structure have a second length difference.

In an implementation form of the first aspect, the first length difference is associated with a wavelength of the optical signal propagating in the optical structure, and an effective index of the first folded arm or the second folded arm of the first optical interferometer structure at the wavelength; and/or the second length difference is associated with the wavelength of the optical signal propagating in the optical structure, and an effective index of the first folded arm or the second folded arm of the second optical interferometer structure at the wavelength.

In an implementation form of the first aspect, the optical structure further comprises a first input port connected to the first optical interferometer structure, wherein the first input port is configured to input an optical signal to the first optical interferometer structure; and a first output port connected to the second optical interferometer structure, wherein the first output port is configured to output an optical signal from the second optical interferometer structure.

In this implementation form, the optical structure is designed with one input and one output.

In an implementation form of the first aspect, the first optical interferometer structure further comprises a first splitter, configured to split the optical signal received from the first input port into the first folded arm and the second folded arm of the first optical interferometer structure; and a first combiner, configured to combine two optical signals received from the first folded arm and the second folded arm of the first optical interferometer structure into one combined optical signal and output the combined optical signal to the second optical interferometer structure.

In an implementation form of the first aspect, the second optical interferometer structure further comprises a second splitter, configured to split an optical signal received from the first optical interferometer structure into the first folded arm and the second folded arm of the second optical interferometer structure; and a second combiner, configured to combine two optical signals received from the first folded arm and the second folded arm of the second optical interferometer structure into one combined optical signal and output the combined optical signal to the first output port.

Optionally, the combiner/splitter component within each optical interferometer structure is adaptable to various types of 1×2 couplers. Examples of such couplers include, but are not limited to, a Trident (an adiabatic 1×2 coupler), 1×2 Multimode Interferometer (MMI), Y-junction, and directional coupler.

In an implementation form of the first aspect, the optical structure further comprises a second output port connected to the first optical interferometer structure, wherein the second output port is configured to output an optical signal from the first optical interferometer structure.

In this implementation form, the optical structure is designed with one input and two outputs. An additional “through” output port of the optical structure, is connected to a single waveguide going across a folded arm twice, via two low-loss waveguide crossings, to access the outside circuit.

In an implementation form of the first aspect, the first combiner is a coupler, and the coupler is configured to output the coupled optical signal from the first optical interferometer structure to the second output port.

The coupler component within the first optical interferometer structure is compatible with a range of 2×2 couplers. This includes, but is not limited to, the 2×2 MMI and directional couplers.

In an implementation form of the first aspect, the first length difference is associated with a type of the coupler.

Optionally, the value of the first length difference depends on the type of the 2×2 coupler used in the first optical interferometer structure.

In an implementation form of the first aspect, the optical structure further comprises a second input port connected to the first optical interferometer structure, wherein the second input port is configured to input the optical signal to the first optical interferometer structure; and a third output port connected to the second optical interferometer structure, wherein the third output port is configured to output an optical signal from the second optical interferometer structure.

In this implementation, the optical structure is designed with two inputs and two outputs. In this design, the two outputs include the first output port and the third output port. This structure may be considered composed of two optical interferometer structures connected by sharing a common 2×2 coupler.

In an implementation form of the first aspect, the first optical interferometer structure further comprises a first input coupler, configured to receive optical signals input from the first input port and the second input port, and output optical signals to the first folded arm and the second folded arm of the first optical interferometer structure; and the second optical interferometer structure further comprises an output coupler, configured to receive optical signals from the first folded arm and the second folded arm of the first optical interferometer structure, and output optical signals to the first output port and the third output port.

In an implementation form of the first aspect, the first length difference is associated with a filter function, and/or the second length difference is associated with a filter function.

The values of length differences depend on the filter function to be implemented.

In an implementation form of the first aspect, at least one of the first optical interferometer structure and the second optical interferometer structure comprises a Mach-Zehnder interferometer (MZI) or a fiber cable.

In one implementation, the whole structure may be considered a planar optical waveguide circuit composed of two 2×2 MZIs. However, this configuration of the cascaded structure is not limited to planar waveguide platforms but is also applicable to a broader range of optical technologies. This includes, but is not limited to, extensions to fiber optics, free-space optics, and other related domains.

In an implementation form of the first aspect, the optical structure is one of the following: an optical switch, an optical attenuator, an optical filter, and a wavelength division multiplexer/demultiplexer.

The proposed optical structure is versatile and can be employed for a range of functionalities. These include, but are not limited to, serving as a VOA, an optical switch, and a TOF.

A second aspect of the disclosure provides an optical structure system, comprising at least two interconnected optical structures, wherein the at least two optical structures are optically connected by sharing a common coupler, and each of the at least two optical structures is the optical structure according to the first aspect or any of its implementation forms.

Optionally, the cascaded optical structure defined in the first aspect can be expanded into a system comprising two or more identical cascaded optical structures interconnected in series by sharing a common 2×2 coupler between the adjacent optical structures. Importantly, the use of the term “identical” in this context is intended to describe the overarching structures themselves, and not necessarily the specific configurations of the individual components within these structures. For instance, when there are two cascaded optical structures in the system, the 1st and 2nd interferometers' arms (from the first optical structure) share one phase shifter, and the 3rd and 4th interferometers' arms (from the second optical structure) share another phase shifter. It is important to note that the two shared phase shifters, although positioned on the same side within their respective structures, are not required to be identical.

It has to be noted that some devices, elements, units, and means described in the present application could be implemented in software or hardware elements or any kind of combination thereof. All steps that are performed by the various entities described in the present application as well as the functionalities described to be performed by the various entities are intended to mean that the respective entity is adapted to or configured to perform the respective steps and functionalities.

Even if, in the following description of specific embodiments, a specific functionality or step to be performed by external entities is not reflected in the description of a specific detailed element of that entity that performs that specific step or functionality, it should be clear for a skilled person that these methods and functionalities can be implemented in respective software or hardware elements or any kind of combination thereof.

### BRIEF DESCRIPTION OF DRAWINGS

The above-described aspects and implementation forms of the present disclosure will be explained in the following description of specific embodiments in relation to the enclosed drawings, in which:

FIG. 1 shows an optical structure according to an embodiment of this disclosure;

FIG. 2 (a) shows a conventional dark-type MZI VOA; (b)-(d) show simulation results of the MZI VOA;

FIG. 3 shows an optical structure according to an embodiment of this disclosure;

FIG. 4 shows the simulation results of the optical structure shown in FIG. 3;

FIG. 5 shows the simulation results of the optical structure shown in FIG. 3;

FIG. 6 shows an optical structure according to an embodiment of this disclosure;

FIG. 7 shows the simulation results of the optical structure shown in FIG. 6;

FIG. 8 shows an optical structure according to an embodiment of this disclosure;

FIG. 9 shows an optical structure system according to an embodiment of this disclosure.

### DESCRIPTION OF EMBODIMENTS

Illustrative embodiments of an optical structure, and a corresponding optical structure system according to embodiments of this disclosure are described in the following with reference to the figures. Although this description provides a detailed example of possible implementations, it should be noted that the details are intended to be exemplary and in no way limit the scope of the application.

Moreover, an embodiment or example may refer to other embodiments or examples. For example, any description including but not limited to terminology, element, process, explanation, and/or technical advantage mentioned in one embodiment or example may also apply to the other embodiments or examples.

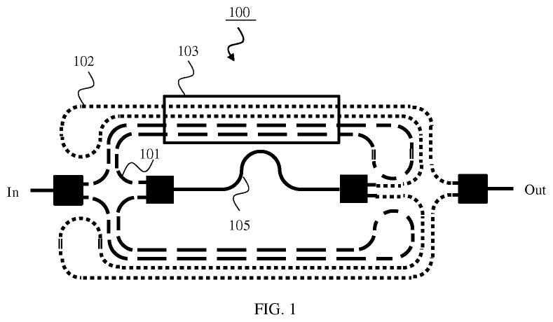

FIG. 1 shows an optical structure 100 according to an embodiment of the disclosure. The optical structure 100 comprises a first optical interferometer structure 101 (illustrated using dashed lines), a second optical interferometer structure 102 (illustrated using dotted lines), and a first phase shifter 103. The first optical interferometer structure 101 and the second optical interferometer structure 102 are optically connected.

Each of the first optical interferometer structure 101 and the second optical interferometer structure 102 comprises a first folded arm and a second folded arm. The first folded arm of the first optical interferometer structure 101 and the first folded arm of the second optical interferometer structure 102 are located on a first side of the optical structure 100 and share the first phase shifter 103. The second folded arm of the first optical interferometer structure 101 and the second folded arm of the second optical interferometer structure 102 are located on a second side of the optical structure 100, wherein the second side is opposite to the first side.

The first phase shifter 103 is configured to perform phase shifting on an optical signal propagating in the first folded arm of the first optical interferometer structure 101 and on an optical signal propagating in the first folded arm of the second optical interferometer structure 102.

Accordingly, this disclosure proposes an optical structure 100 with two folded optical interferometer arms on two sides of the optical structure 100, such as the top and bottom sides. Arms on the same side share the same phase shifter. The two arms on the same side may be folded in a way that achieves a balanced/symmetric phase-shifting on the two arms sharing the same phase-shifter. For instance, the folded arms may have enough waveguide-to-waveguide spacing to avoid optical waveguide mode cross-coupling. The folded arms may be specifically designed to minimize the insertion loss and to filter out high-order waveguide mode by using proper waveguide bends. Such a structure may be designed to optimize space utilization and significantly reduce the overall footprint.

In one implementation, the optical structure 100 may be a planar optical waveguide circuit composed of two 1×1 MZIs connected by a single optical waveguide.

For ease of understanding of this application, a MZI, which notably employs heaters as thermo-optic phase shifters, is first introduced here. The MZI is composed of two couplers and phase delay waveguides, and is widely used in VOAs, optical switches, and TOFs in various planar waveguide platforms.

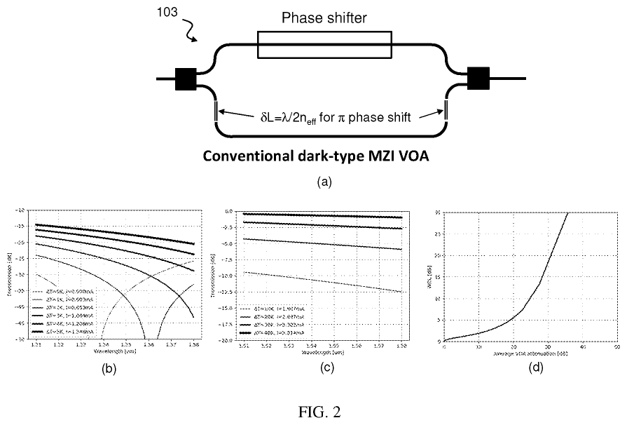

In a conventional dark-type MZI VOA as shown in FIG. 2(a), light should be blocked with a high extinction ratio (ER) at zero tuning power. Therefore, the two arms of the MZI should have a length difference of λ/(2neff), i.e. π phase shift to block light with destructive interference at the MZI's combiner.

Due to the chromatic dispersion of the planar optical waveguide, the optical length difference is wavelength-dependent, so WDL is not avoidable in a dark-type MZI VOA with a non-zero arm length difference. The VOA's WDL increases towards higher attenuation (as shown in FIG. 2(b), FIG. 2(c)). It also increases as VOA operating bandwidth increases, which deteriorates the attenuation accuracy of the VOA. The VOA's ER also decreases fast as operating bandwidth increases.

In order to simultaneously achieve all of the desired functionalities, this disclosure presents a planar waveguide structure satisfying all the challenging points mentioned above at the same time.

In one embodiment, the optical structure 100 includes the following features:
1. Cascaded MZI configuration with folded MZI arms.
2. Folded arms from the same side of each MZI are put close to each other, with a gap just enough to avoid waveguide-to-waveguide cross-coupling, to share the same phase shifter.
3. Optionally, folded arms from the other side of each MZI are also put close to each other in the same way as the other side to share another phase shifter.
4. Depending on the couplers and delay lengths in the MZIs, the optical structure 100 can be used for various functionalities, e.g. VOA, optical switch, TOF, etc.
5. The configuration of the otpical structure 100 optimizes space utilization to achieve a small footprint.

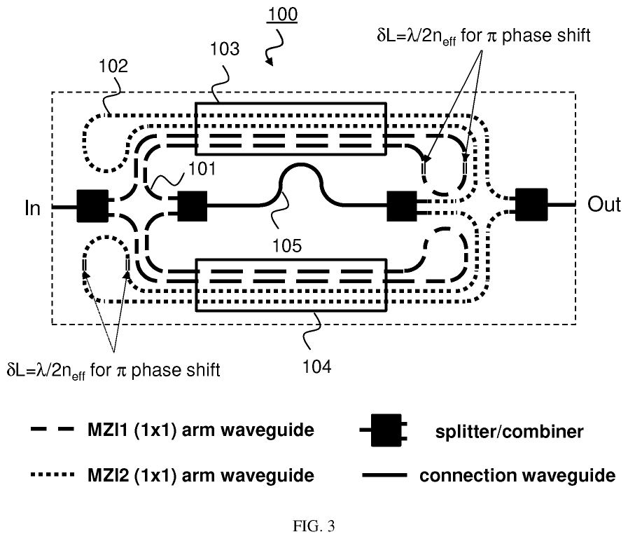

FIG. 3 shows an optical structure 100 according to an embodiment of this disclosure. The structure of FIG. 3 is based on the structure shown in FIG. 1. The structural details of the embodiment illustrated in FIG. 1, particularly the manner in which the arms are folded, are equally applicable to this instance and also to the following embodiments.

In this embodiment, the optical structure 100 further comprises a second phase shifter 104. The second folded arm of the first optical interferometer structure 101 and the second folded arm of the second optical interferometer structure 102 share the second phase shifter 104.

In order to make the top and bottom sides of the optical structure structurally symmetric, a second phase shifter 104 is further introduced. It may be considered that the first phase shifter 103 is an operational phase shift, and the second phase shifter 104 is a non-operational (dummy) phase shift. Notably, in this embodiment, the first phase shift 103 is configured to be used as the operating phase shift. However, the system's functionality remains consistent irrespective of whether the upper or lower phase shifter is designated as the operational unit or the non-operational (dummy) unit. That is, it is also possible that the second phase shifter 104 works as the operational phase shift, and the first phase shifter 103 is the dummy phase shift. In this case, instead of the first phase shifter 103, the second phase shifter 104 is configured to perform phase shifting on an optical signal propagating in the second folded arm of the first optical interferometer structure 101 and on an optical signal propagating in the second folded arm of the second optical interferometer structure 102.

Either the MZI (i.e., the optical interferometer structure 101 or 102) has two folded waveguide arms on both the top and bottom sides. Arms on the same side of the two MZIs share the same phase shifter (e.g. thermo-optic heater), with each phase shifter having four waveguide passes.

In this optical structure 100, the first optical interferometer structure 101 and the second optical interferometer structure 102 are connected with a connection waveguide 105 (illustrated using the solid line).

Notably, the first folded arm and the second folded arm of the first optical interferometer structure 101 have a first length difference. Optionally, the first length difference is associated with a wavelength of the optical signal propagating in the optical structure 100, and an effective index of the first folded arm or the second folded arm of the first optical interferometer structure 101 at the wavelength.

The second folded arm and the first folded arm of the second optical interferometer structure 102 may have a second length difference. Similarly, the second length difference is associated with the wavelength of the optical signal propagating in the optical structure 100, and an effective index of the first folded arm or the second folded arm of the second optical interferometer structure 102 at the wavelength.

Both the first and and second MZIs have an arm length difference of λ/(2n_eff) . The extra length is applied on different sides of the arms of the two MZIs respectively. For either of the two MZIs, the specific side of the arm that possesses the extra length, λ/(2n_eff) , does not impact the overall functionality or performance.

In this embodiment, the optical structure 100 further comprises a first input port connected to the first optical interferometer structure 101, and a first output port connected to the second optical interferometer structure 102. The first input port is configured to input an optical signal to the first optical interferometer structure 101, and the first output port is configured to output an optical signal from the second optical interferometer structure 102.

The first optical interferometer structure 101 further comprises a first splitter and a first combiner. The first splitter is configured to split the optical signal received from the first input port into the first folded arm and the second folded arm of the first optical interferometer structure 101; and the first combiner is configured to combine two optical signals received from the first folded arm and the second folded arm of the first optical interferometer structure 101 into one combined optical signal and output the combined optical signal to the second optical interferometer structure 102.

The second optical interferometer structure 102 further comprises a second splitter and a second combiner. The second splitter is configured to split an optical signal received from the first optical interferometer structure 101 into the first folded arm and the second folded arm of the second optical interferometer structure 102, and the second combiner is configured to combine two optical signals received from the first folded arm and the second folded arm of the second optical interferometer structure 102 into one combined optical signal and output the combined optical signal to the first output port.

Optionally, the combiner/splitter component within each optical interferometer structure is adaptable to various types of 1×2 couplers. Examples of such couplers include, but are not limited to, the Trident (an adiabatic 1×2 coupler), 1×2 MMI, Y-junction, and directional coupler.

This type of optical structure 100 allows for a low WDL over a broad bandwidth. The incorporation of the shared phase shifter (i.e., the first phase shift 103) enables a uniform phase shift being consistently applied to both folded arms of each distinct branch, thus ensuring synchronous phase modulation across the system. Hence, the first optical interferometer structure's WDL is largely compensated by the second optical interferometer structure's reverse WDL in the transmission spectrum. Consequently, the WDL of the entire structure is effectively maintained at a minimal level, ensuring optimal performance across an extensive optical bandwidth range.

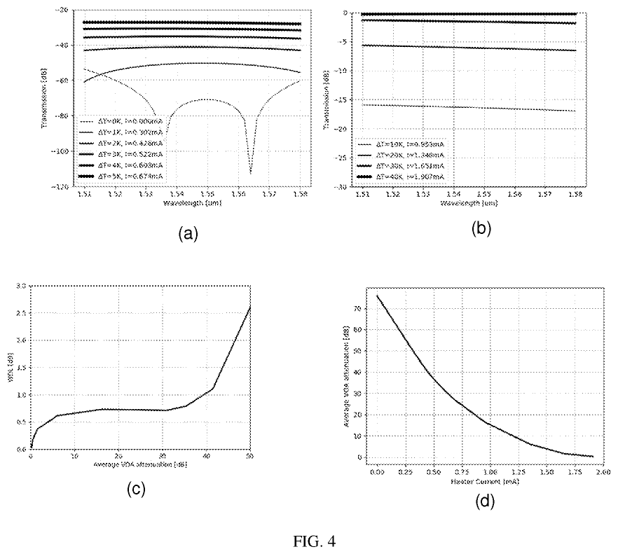

FIG. 4(a)-FIG. 4(d) show the simulation results of the proposed optical structure. FIG. 4(a) and FIG. 4(b) shows simulation results of transmission spectra of a cascaded-MZI VOA with a shared phase shifter at various MZI arm temperature differences, ΔT, and tuning currents applied on an operating heater. FIG. 4(c) shows a simulated WDL (across the C-band) versus the averaged attenuation of a cascaded MZI VOA with a shared phase shifter. Due to the low wavelength dependency, this VOA's initial attenuation level is also kept at a high level over a large initial range of tuning current across wide optical bandwidth, as illustrated in FIG. 4(d). FIG. 4(d) shows a simulated average attenuation level over C-band of a cascaded-MZI VOA with a shared phase shifter versus tuning current applied on the operating heater.

It is recognized that the performance of a conventional dark-type MZI VOA is notably susceptible to process errors. This susceptibility primarily arises from variations in the MZI's phase delay, attributable to dimensional fluctuations in the waveguide due to processing inconsistencies. By contrast, the structure presented in this disclosure demonstrates a marked insensitivity to such process errors, attributable to the fact that the same arm length difference is used on the two cascaded MZIs, so that the same amount of process-error-induced spectral response change applied on the two MZIs respectively compensate each other in the transmission spectrum.

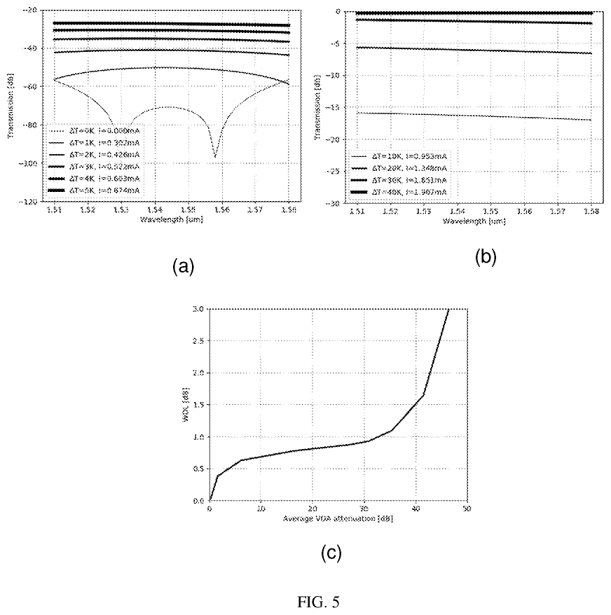

FIG. 5(a)-FIG. 5(c) show the simulated transmission spectra and WDL versus attenuation level for this proposed MZI VOA structure with a waveguide dimension (width and height) at its process corner—6σ deviated from a target design. In particular, FIG. 5(a) and FIG. 5(b) shows simulation results of transmission spectra of a cascaded-MZI VOA with a shared phase shifter having a waveguide dimension at its process corner—6σ deviated from target design at various MZI arm temperature difference, ΔT, and tuning current applied on an operating heater. FIG. 5(c) shows a simulated WDL (across C-band) versus averaged attenuation of a cascaded-MZI VOA with a shared phase shifter having a waveguide dimension at its process corner—6σ deviated from the target design.

The comparison reveals that the differences in spectral response between FIG. 4(a) and FIG. 5(a), FIG. 4(b) and FIG. 5(b), as well as between FIG. 4(c) and FIG. 5(c), are small across all tuning currents and attenuation levels.

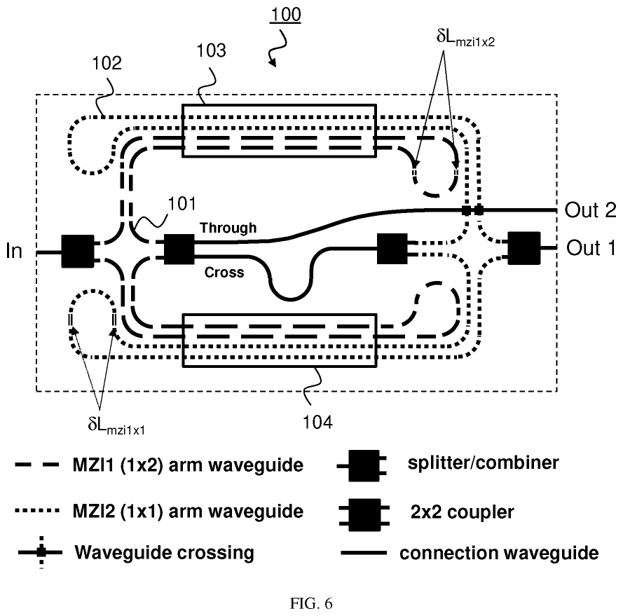

FIG. 6 shows an optical structure 100 according to an embodiment of this disclosure. The structure of FIG. 6 is based on the structure shown in FIG. 3.

In this embodiment, the optical structure 100 further comprises a second output port connected to the first optical interferometer structure 101. The second output port is configured to output an optical signal from the first optical interferometer structure 101.

The whole optical structure 100 designed in this embodiment is a planar optical waveguide circuit composed of a 1×2 MZI (i.e., the first optical interferometer structure 101) and a 1×1 MZI (i.e., the second optical interferometer structure 102) connected by a single optical waveguide between the “cross” output port of the 1×2 MZI and input port of the 1×1 MZI. The first output port is referred to as the “cross” output port. The other “through” output port of the 1×2 MZI, is connected to a single waveguide going across a folded MZI arm twice, via two low-loss waveguide crossings, to access the outside circuit. The second output port is referred to as the “through” output port.

In this embodiment, the first combiner of the first optical interferometer structure 101 is a coupler, and the coupler is configured to output the combined optical signal from the first optical interferometer structure 101 to the second output port.

Similarly to the previous embodiments, the combiner/splitter component within each optical interferometer structure is adaptable to various types of 1×2 couplers. Examples of such couplers include, but are not limited to, the Trident (an adiabatic 1×2 coupler), 1×2 MMI, Y-junction, and directional coupler.

Optionally, the coupler component within the first optical interferometer structure 101 is compatible with a range of 2×2 couplers. This includes, but is not limited to, the 2×2 MMI and directional couplers.

Both the 1×1 and 1×2 MZIs have two folded waveguide arms on both the top and bottom sides. Arms on the same side of the two MZIs share the same phase shifter (i.e., the first phase shifter 103, the second phase shifter 104), with each phase shifter having four waveguide passes.

The arms of the first MZI (1×2) have a length difference, δL=δL_mzi1×2, with the extra length possessed by the top side of MZI arm. The value of δL_mzi1×2 depends on the type of the 2×2 coupler used in the 1×2 MZI, e.g. δL_mzi1×2=λ/(4n_eff) for a 2×2 MMI. That means the first length difference is associated with a type of coupler, the wavelength of the optical signal propagating in the optical structure 100, and an effective index of the first folded arm or the second folded arm of the first optical interferometer structure 101 at the wavelength.

The arms of the second MZI (1×1) have a length difference, δL_mzi1×1=λ/(2n_eff), with the extra length possessed by the bottom side of MZI arm. That is, the second length difference is still associated with the wavelength of the optical signal propagating in the optical structure 100, and an effective index of the first folded arm or the second folded arm of the second optical interferometer structure 102 at the wavelength.

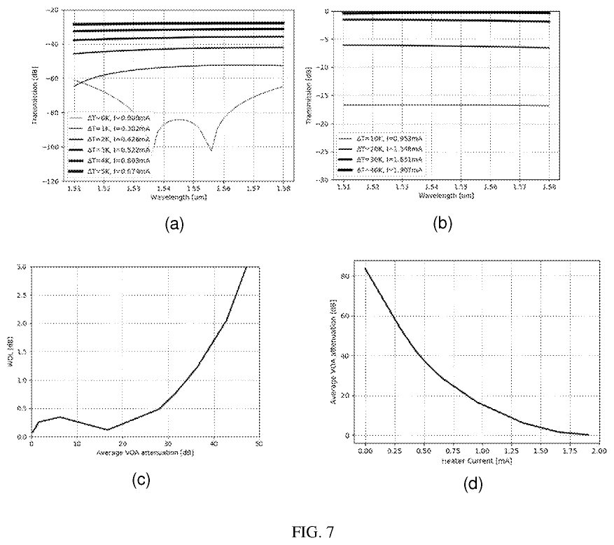

Compared to the embodiment shown in FIG. 3, the structure shown in FIG. 6 has an extra output port, out2, for the purpose of optical switching as well as the other port, Out1, for the purpose of optical attenuation. The 2×2 coupler in the 1×2 MZI will add extra phase delay, φ_(2×2_cross), for cross-coupling, so that the arm length difference of the 1×2 MZI is calculated by δL=λ(π−φ_(2×2_cross) )/(2πn_eff) to achieve a total amount of π phase shift. In conjunction with the cascaded 1×1 MZI, the optical route In-Cross-Out1 provides a similar low-WDL optical attenuation as described in the embodiment shown in FIG. 3. The simulated transmission spectra versus temperature/current tuning and WDL analysis are given in FIG. 7(a) and FIG. (b), respectively. Similar to the previous embodiment, this optical switch's initial attenuation level at port, Out1, is kept at a high level over a large initial range of tuning current across a wide optical bandwidth (see FIG. 7(d)).

FIG. 7(a) and FIG. 7(b) shows a simulation result of transmission spectra of a cascaded-MZI optical switch with a shared phase shifter at various MZI arm temperature differences, ΔT, and tuning currents applied on an operating heater. FIG. 7(c) shows a simulated WDL (across the C-band) versus the averaged attenuation of a cascaded-MZI optical switch with a shared phase shifter. Due to the low wavelength dependency, the initial attenuation level of said optical switch is also kept at a high level over a large initial range of tuning current across a wide optical bandwidth, as illustrated in FIG. 7(d). FIG. 7(d) shows a simulated average attenuation level over C-band of a cascaded-MZI optical switch with a shared phase shifter versus the tuning current applied to the operating heater.

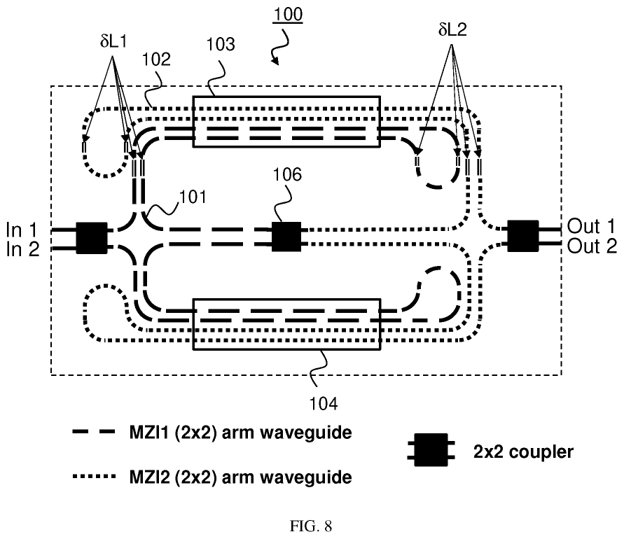

FIG. 8 shows an optical structure 100 according to an embodiment of this disclosure. The structure of FIG. 8 is based on the structure shown in FIG. 3 or FIG. 6. The optical structure 100 comprises a first optical interferometer structure 101 and a second optical interferometer structure 102, which are connected through a common coupler 106.

The whole structure designed in this embodiment may be a planar optical waveguide circuit composed of two 2×2 MZIs connected by a common 2×2 coupler.

Compared with the embodiment shown in FIG. 6, this optical structure 100 further comprises a second input port connected to the first optical interferometer structure 101, wherein the second input port is configured to input the optical signal to the first optical interferometer structure 101. The optical structure 100 further comprises a third output port, which is marked as “Out2” in the figure, connected to the second optical interferometer structure 102, wherein the third output port is configured to output an optical signal from the second optical interferometer structure 102. It is important to clarify that the designation ‘third output port’ employed herein serves solely to differentiate it from the “second output port” depicted in the embodiment shown in FIG. 6. This terminology does not suggest that the optical structure 100 includes three output ports.

In this embodiment, the first optical interferometer structure 101 further comprises a first input coupler, configured to receive optical signals input from the first input port and the second input port, and output optical signals to the first folded arm and the second folded arm of the first optical interferometer structure 101.

The second optical interferometer structure 102 further comprises an output coupler, configured to receive optical signals from the first folded arm and the second folded arm of the first optical interferometer structure 101, and output optical signals to the first output port and the third output port.

Notably, the coupler component within the first optical interferometer structure 101, the second optical interferometer structure 102, or the common coupler 106, is compatible with a range of 2×2 couplers. This includes, but is not limited to, the 2×2 MMI and directional couplers, if both input ports or both output ports are present.

The input/output couplers in the structure can be various types of 1×2 couplers, such as 1×2 MMI, Y-junction, or the Trident, if only one input/output is present.

Both MZIs have two folded waveguide arms on both top and bottom sides. Arms on the same side of the two MZIs share the same phase shifter (e.g., thermo-optic heater), with each phase shifter having four waveguide passes.

It is worth mentioning that in this embodomient, both the first phase shifter 103 and the second phase shifter 104 are operational phase shifts. They are both configured to perform phase shifting on an optical signal propagating in the MZIs.

The phase sections deciding the arm length differences of the 2 MZIs, δL1, and δL2, are applied on the two MZIs'arms on the same side. The values of δL1 and δL2 depend on the filter function to be implemented.

The structure proposed in this embodiment allows the same phase shift control for both stages if the same amount of phase shift needs to be applied to the two MZIs respectively. Phase sections are close together, so random phase variations are small. Low power consumption can be achieved due to the efficient use of a phase shifter. Space utilization is optimized thereby achieving a small footprint.

Notably, this structure can be repeated so that a lattice MZI TOF can be created with 2*N+1 couplers where N is the number of shared phase sections to tune.

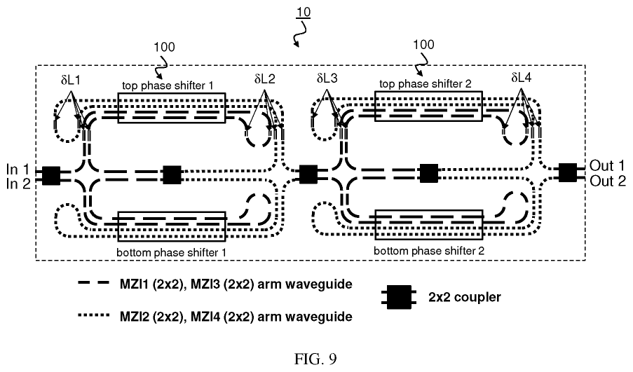

FIG. 9 shows an optical structure system 10 according to an embodiment of this disclosure. The optical structure system 10 of FIG. 9 is based on the structure shown in FIG. 8. In particular, the optical structure system 10 comprises at least two interconnected optical structures 100. The at least two optical structures 100 are optically connected in series by sharing a common 2×2 coupler. Each of the at least two optical structures 100 is the optical structure 100 shown in FIG. 8.

In this disclosure, the cascaded optical structure 100 defined in the previous embodiments can be expanded into a system comprising two or more identical cascaded optical structures interconnected in series. Importantly, the use of the term “identical” in this context is intended to describe the overarching structures themselves, and not necessarily the specific configurations of the individual components within these structures. For instance, when there are two cascaded optical structures in the system, the 1st and 2nd interferometers' arms (from the first optical structure) share one phase shifter, and the 3rd and 4th interferometers' arms (from the second optical structure) share another phase shifter. It is important to note that the two shared phase shifters, although positioned on the same side within their respective structures, are not required to be identical.

It should be understood that the concept of shared phase shifter on two cascaded MZI arms also applies to other optoelectronic components using MZI structures in planar waveguide platforms, e.g. MZI-TOF (tunable optical filter), MZI-WDM (wavelength division (de)multiplexer). The configuration of the cascaded MZI structure disclosed here also applies to the application beyond the planar waveguide platform, e.g., fiber optics, free-space optics, etc.

To summarize, this disclosure proposes the configuration of cascaded optical interferometer structures (e.g., MZI structures) and the arrangement of phase delay in each folded arm. This type of optical structure allows low wavelength dependency, high attenuation level, and extinction ratio over a large initial range of tuning current across broad optical bandwidth. The concept of phase tuning with a shared phase shifter on two folded MZI arms makes the spectral response very tolerant to process-related waveguide dimensional variation. It achieves a high tuning efficiency and low power consumption. The folded optical waveguide routing configuration maximizes space utilization and thus achieves a small footprint.

The present disclosure has been described in conjunction with various embodiments as examples as well as implementations. However, other variations can be understood and effected by those persons skilled in the art and practicing the claimed embodiments of the disclosure, from the studies of the drawings, this disclosure, and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutually different dependent claims does not indicate that a combination of these measures cannot be used in an advantageous implementation.

1. An optical structure (100), comprising:
a first optical interferometer structure (101), a second optical interferometer structure (102), and a first phase shifter (103),
wherein the first optical interferometer structure (101) and the second optical interferometer structure (102) are optically connected, and each of the first optical interferometer structure (101) and the second optical interferometer structure (102) comprises a first folded arm and a second folded arm,
wherein the first folded arm of the first optical interferometer structure (101) and the first folded arm of the second optical interferometer structure (102) are located on a first side of the optical structure (100) and share the first phase shifter (103), and the second folded arm of the first optical interferometer structure (101) and the second folded arm of the second optical interferometer structure (102) are located on a second side of the optical structure (100), wherein the second side is opposite to the first side,
wherein the first phase shifter (103) is configured to perform phase shifting on an optical signal propagating in the first folded arm of the first optical interferometer structure (101) and on an optical signal propagating in the first folded arm of the second optical interferometer structure (102).

2. The optical structure (100) according to claim 1, further comprising a second phase shifter (104),
wherein the second folded arm of the first optical interferometer structure (101) and the second folded arm of the second optical interferometer structure (102) share the second phase shifter (104).

3. The optical structure (100) according to claim 1, further comprising an optical connection structure, configured to optically connect the first optical interferometer structure (101) and the second optical interferometer structure (102),
wherein the optical connection structure is a connection waveguide, or a common coupler (106) configured to receive optical signals from the first folded arm and the second folded arm of the first optical interferometer structure (101), and output optical signals to the first folded arm and the second folded arm of the second optical interferometer structure (102).

4. The optical structure (100) according to claim 1, wherein the first folded arm and the second folded arm of the first optical interferometer structure (101) have a first length difference and/or wherein the second folded arm and the first folded arm of the second optical interferometer structure (102) have a second length difference.

5. The optical structure (100) according to claim 4, wherein
the first length difference is associated with a wavelength of the optical signal propagating in the optical structure (100), and an effective index of the first folded arm or the second folded arm of the first optical interferometer structure (101) at the wavelength; and/or
the second length difference is associated with the wavelength of the optical signal propagating in the optical structure (100), and an effective index of the first folded arm or the second folded arm of the second optical interferometer structure (102) at the wavelength.

6. The optical structure (100) according to claim 1, further comprising:
a first input port connected to the first optical interferometer structure (101), wherein the first input port is configured to input an optical signal to the first optical interferometer structure (101); and
a first output port connected to the second optical interferometer structure (102), wherein the first output port is configured to output an optical signal from the second optical interferometer structure (102).

7. The optical structure (100) according to claim 6, wherein the first optical interferometer structure (101) further comprises:
a first splitter, configured to split the optical signal received from the first input port into the first folded arm and the second folded arm of the first optical interferometer structure (101); and
a first combiner, configured to combine two optical signals received from the first folded arm and the second folded arm of the first optical interferometer structure (101) into one combined optical signal and output the combined optical signal to the second optical interferometer structure (102).

8. The optical structure according to claim 6, wherein the second optical interferometer structure (102) further comprises:
a second splitter, configured to split an optical signal received from the first optical interferometer structure (101) into the first folded arm and the second folded arm of the second optical interferometer structure (102); and
a second combiner, configured to combine two optical signals received from the first folded arm and the second folded arm of the second optical interferometer structure (102) into one combined optical signal and output the combined optical signal to the first output port.

9. The optical structure (100) according to claim 6, further comprising:
a second output port connected to the first optical interferometer structure (101), wherein the second output port is configured to output an optical signal from the first optical interferometer structure (101).

10. The optical structure (100) according to claim 9, wherein the first combiner is a coupler, and the coupler is configured to output the coupled optical signal from the first optical interferometer structure (101) to the second output port.

11. The optical structure (100) according to claim 10, wherein the first length difference is associated with a type of the coupler.

12. The optical structure (100) according to claim 1, further comprising:
a second input port connected to the first optical interferometer structure (101), wherein the second input port is configured to input the optical signal to the first optical interferometer structure (101); and
a third output port connected to the second optical interferometer structure (102), wherein the third output port is configured to output an optical signal from the second optical interferometer structure (102).

13. The optical structure (100) according to claim 12, wherein
the first optical interferometer structure (101) further comprises a first input coupler, configured to receive optical signals input from the first input port and the second input port, and output optical signals to the first folded arm and the second folded arm of the first optical interferometer structure (101); and
the second optical interferometer structure (102) further comprises an output coupler, configured to receive optical signals from the first folded arm and the second folded arm of the first optical interferometer structure (101), and output optical signals to the first output port and the third output port.

14. The optical structure (100) according to claim 12, wherein the first length difference is associated with a filter function and/or wherein the second length difference is associated with a filter function.

15. An optical structure (100) system, comprising at least two interconnected optical structures (100), wherein the at least two optical structures (100) are optically connected by sharing a common coupler (106), and each of the at least two optical structures (100) comprising:
a first optical interferometer structure (101), a second optical interferometer structure (102), and a first phase shifter (103),
wherein the first optical interferometer structure (101) and the second optical interferometer structure (102) are optically connected, and each of the first optical interferometer structure (101) and the second optical interferometer structure (102) comprises a first folded arm and a second folded arm,
wherein the first folded arm of the first optical interferometer structure (101) and the first folded arm of the second optical interferometer structure (102) are located on a first side of the optical structure (100) and share the first phase shifter (103), and the second folded arm of the first optical interferometer structure (101) and the second folded arm of the second optical interferometer structure (102) are located on a second side of the optical structure (100), wherein the second side is opposite to the first side,
wherein the first phase shifter (103) is configured to perform phase shifting on an optical signal propagating in the first folded arm of the first optical interferometer structure (101) and on an optical signal propagating in the first folded arm of the second optical interferometer structure (102).

16. The optical structure (100) system according to claim 15, further comprising:
a second input port connected to the first optical interferometer structure (101), wherein the second input port is configured to input the optical signal to the first optical interferometer structure (101); and
a third output port connected to the second optical interferometer structure (102), wherein the third output port is configured to output an optical signal from the second optical interferometer structure (102).

17. The optical structure (100) system according to claim 16, wherein
the first optical interferometer structure (101) further comprises a first input coupler, configured to receive optical signals input from the first input port and the second input port, and output optical signals to the first folded arm and the second folded arm of the first optical interferometer structure (101); and
the second optical interferometer structure (102) further comprises an output coupler, configured to receive optical signals from the first folded arm and the second folded arm of the first optical interferometer structure (101), and output optical signals to the first output port and the third output port.

18. The optical structure (100) system according to claim 16, wherein the first length difference is associated with a filter function and/or wherein the second length difference is associated with a filter function.
